(19) United States
(12) Patent Application Publication
(10) Pub. No.: US 2015/0012284 A1
(43) Pub. Date: Jan. 8, 2015

(54) COMPUTERIZED EXERCISE EQUIPMENT PRESCRIPTION APPARATUS AND METHOD

(71) Applicant: Peter Schenk, Salt Lake City, UT (US)

(72) Inventors: Peter Schenk, Park City, UT (US); Robert Starr, Salt Lake City, UT (US)

(73) Assignee: Peter Schenk, Salt Lake City, UT (US)

(21) Appl. No.: 14/267,532

(22) Filed: May 1, 2014

Related U.S. Application Data
(60) Provisional application No. 61/842,819, filed on Jul. 3, 2013.

(51) Int. Cl. G06F 19/00

(52) U.S. Cl. CPC G06F 19/3481
USPC 705/2

(57) ABSTRACT

A computerized prescription process specifying exercise regimens for a patient's chronic condition aids a physician in formulating a prescription and referring the patient to a facility with suitable fitness and health professionals to implement the exercise regimen as medicine for the condition. The system requires minimal time and inputs to access records and process health data unique to a patient, beginning with identification and chronic health conditions to be treated. The system may integrate information, track compliance, collect and manage health metrics, and communicate to and from a patient through a smart phone, PDA, or other wireless, network-aware device

### RELATED APPLICATIONS

This application claims the benefit of U.S. Provisional Patent Application Ser. No. 61/842,819, filed Jul. 3, 2013, entitled COMPUTERIZED EXERCISE EQUIPMENT PRESCRIPTION APPARATUS AND METHOD, which is hereby incorporated by reference in its entirety.

### BACKGROUND

1. Field of the Invention

This invention relates to exercise equipment and, more particularly, to novel systems and methods for computerized integration of exercise information.

2. Background Art

Exercise fitness equipment typically includes a mechanical device with which a user interacts in order to provide certain bodily motions while stressing various muscles and muscle groups. Some exercise equipment is directed to strength training. This is commonly referred to anaerobic exercise equipment. In general, anaerobic exercise is directed to overstressing muscles and muscle groups in order to motivate those muscles and muscle groups to conduct repairs and additional growth in response to the overstressing. Other equipment is designated aerobic exercise equipment. Aerobic exercise is typically directed to exercising muscles in muscle groups at a rate consistent with the ability of the human body to intake and process oxygen. Thus, aerobic exercise is typically more repetitive, over a longer period of time, at a lower level of stress, compared to anaerobic exercise.

Exercise equipment is traditional in training athletes for specific activities and events. Rowing exercise machines were developed and patented by coaches and professors at Harvard University in the early 1800's. Meanwhile, equipment and devices to replicate walking, running, cycling, and the like are also ubiquitous.

Modern exercise equipment may benefit from inclusion of various control mechanisms. Controls may be mechanical, electrical, electronic, computerized, or the like.

However, it would be an advance in the art to integrate physical therapy and medical recommendations into exercise prescriptions. A computerized system for acquiring information, excerpting it, and speeding the process of prescribing exercise as a medicine is needed. Also needed is integration for controlling exercise equipment and feeding back information to and about users. Providing information from medical professionals to equipment, users, or both, could benefit professionals with significant exercise and medical information from the exercise equipment and the prescribing medical professionals.

### BRIEF SUMMARY OF THE INVENTION

In view of the foregoing, in accordance with the invention as embodied and broadly described herein, a method and apparatus are disclosed in one embodiment of the present invention as including a system integrating exercise equipment, computers, databases, medical professional computers, exercise equipment control computers, and personal computers of users in order to facilitate the making and follow up of exercise prescriptions and recommendations. In certain embodiments, a system in accordance with the invention may make recommendations to physicians based on chronic conditions diagnosed within a patient.

A physician may also select and recommend certain regimens for treatment or rehabilitation of a patient user. Meanwhile, a system in accordance with the invention may recommend to patients an appropriate health and fitness regimen. It may support a doctor in recommending a patient to an appropriate health and physical fitness professional based on a patient's chronic condition.

For example, a database of health professionals, such as physical therapists, physicians, or the like may be maintained in a network of health care professionals. This network may be controlled or administered by a medical facility, such as a hospital. In other embodiments, that group may be created and managed by an insurance entity that maintains a portfolio of acceptable or pre-authorized medical professionals accessible to insured users.

In certain embodiments, a system in accordance with the invention may include a database containing information characterizing and identifying individual physicians, groups of physicians, health organizations, fitness professionals, hospitals, other physical facilities, other service providers, insurance companies, patients, users, and the like. In certain embodiments, various databases may be owned and controlled by different entities. In other embodiments, a database may be owned, managed, and controlled by a single entity.

Similarly, access to the database may be provided according to certain access codes, controls, and so forth. Thus, information may be made readily available to individuals, healthcare professionals, fitness professionals and the like, based on authorizations. Meanwhile, access may be closely controlled in order to protect patient privacy, physician opinions, and so forth.

In one embodiment, a physician account may be provided in order to access a physician module. The physician module may provide to a physician the ability to enroll and identify a patient, assign a chronic condition selected from a list of likely, common, or otherwise pre-identified conditions. For example, diabetes, arthritis, and the like may be sufficiently pervasive that each should be included in a menu for rapid identification and selection by a physician.

Each physician or practice may have access through its own account in the system in order to access functions appropriate to a position of responsibility, duty to patients, privacy requirements, patient responsibility, care facility affiliation, a combination thereof, or the like. In certain embodiments, a physician may enroll a patient, identify the patient, assign certain conditions, or identify the patient as a healthy adult.

At the time of entry, the system may automatically review a health history and recommend an exercise prescription based on timing, frequency, duration, intensity, or the like for a regular cardio-vascular exercise program. Similarly, a strength training procedure may be provided by a system in accordance with the invention. The system may assist in formulating a recommendation to a health or fitness professional, such as a physical therapist, fitness coach, or the like.

In other embodiments, recommendations for exercise may be made according to monitoring by a professional, in order to be part of an exercise prescription. In such an embodiment, the physician may create a prescription for recommendations and information provided by the system. Likewise, a physician may modify a prescription recommended by the system. Meanwhile, the system may itself make recommendations to limit, withdraw, or modify a prescription recommended by the physician based on information checked in the system. Similarly, physicians may provide modifications to one another, by way of second opinions, concurring opinions, or the like.

Once a prescription is complete, the system may recommend one or more appropriate health or fitness professionals, groups, facilities, a combination, or subcombination thereof to implement the prescription. For example, a system may recommend certain medical, fitness, rehabilitation, cardiac rehabilitation, muscular rehabilitation, pulmonary rehabilitation, diabetic maintenance, or other specialist qualified to implement a prescription with a patient. Meanwhile, a patient who wants to manage their own prescription at home, or otherwise on their own may also be provided access to their own records and their own recommendations from the system as confirmed, modified, or both by their physician.

A health fitness professional will typically be notified of any new referral added to that professional's account by any physician module making the referral. Typically, an email with instructions on how to set up an account may also be provided to a person or entity, such as a fitness professional or patient. By logging in, a patient may take certain steps to engage in an exercise prescription regimen. Meanwhile, communication modules may facilitate communication between a health or fitness professional and a patient, as well as between them and the exercise equipment that is used. Thus, a completely integrated system of information available to a patient, physician, health or fitness professional and the equipment used may be implemented.

A facility module may be thought of as a system of executables associated with facility accounts or center accounts. That is, a facility or center may provide to health and fitness professionals various tools in order to manage members. For example, the facility module or center module may provide to medical professionals and health or fitness professionals workout programs, proposed systems, equipment, regimens, and so forth to meet the needs of an exercise prescription from a physician or other medical professional.

The facilities module may provide monitoring of health metrics associated with a patient, such as weight, blood pressure, cholesterol, body fat percentage, blood glucose, exercise results, proposed exercise monitoring, heart rates, and so forth. Thus, the facilities module may monitor patient exercise results to insure compliance with a prescription.

Likewise, up-to-the-minute reporting may be provided into a database reflecting compliance by a patient (user) with an exercise prescription. In certain embodiments, a system in accordance with the invention may also provide communications directly between the facility (center) and the patient, the facility and the physician, patient and physician, and so forth. Communications modules may be implemented to facilitate and simplify such communications. Moreover, asynchronous communications, such as messaging, emails, and the like may free up patients, physicians, physical therapists, health and fitness professionals and facilities management personnel to deal with data inputs and outputs on their own schedules, rather than requiring intervention at the time a particular machine is in use or a patient is in exercise or therapy.

A patient module manages patient information and activities. For example, a patient may have a patient account in a system that provides access to a patient in order to select a workout calendar if managing their own exercise program. Meanwhile, an exercise calendar may be provided from the facility in accordance with the prescription. Scheduling may be facilitated by an exercise facility relying on its facility module to organize, schedule, and otherwise work around patients' schedules in order to provide to a patient, available exercise equipment at a particular time, suitable for the patient, and consistent with an exercise program prescribed. Meanwhile, a patient may thereby provide available times for exercise, in order to coordinate through the patient module with the facilities module a schedule suitable to the availability of proper equipment and possibly supervision, at a facility, at a time suitable for a patient. Thus, these scheduling negotiations may be done through calendaring automatically by a system in accordance with the invention.

Meanwhile, a patient may log results and update health metrics in order to communicate with a facility. In other embodiments, the patients, may have certain exercise equipment available to them in their homes. For example, treadmills are ubiquitous, as are exercise cycles, and the like. To the extent that an individual may have personal equipment, that equipment may access the facility module in order to report in as an adjunct to the facility equipment. Accordingly, scheduling is simplified, but logging in of information is still maintained. Thus, the system may integrate all exercise activities, exercise equipment, and different facilities, both personal, and commercial, in order to log each type of exercise, with each type of equipment, reflecting overall prescription compliance by a user.

Patient exercise may be supported directly by Internet connection of personal or commercial equipment to a database of the system. Meanwhile, flash memory drives, computerized applications, personal digital assistant applications, such as smart phone application, and the like may be relied upon to communicate, display, coordinate, download, upload, and otherwise exchange data, prescriptions, feedback and other information between devices and personnel within the system in accordance with the invention.

In certain embodiments, clients may obtain full access to account information, health histories, exercise compliance histories, and other health metrics. This access may be made available directly to a PDA, smart phone, tablets, computer, or the like. In certain embodiments, a wireless connection from a smart phone may provide uploading and downloading of information between exercise equipment, facility systems, and the like in order to simplify reporting, simplify communication, and assure more complete information availability to physicians, physical therapists, health and fitness professionals, and patients.

As used herein, any reference to a “physician” should be considered as including either an actual physician or any clinician acting under the physician's direction as part of that physician's office.

The hardware, software and systems herein described are used by way of example. Any computing device may be or include a desktop, fixed, embedded, standalone, or portable computing devices of any type. This may include smart phones, tablets, personal digital assistants, specialty devices, activity monitors, recorders, or the like. Such devices may be used to communicate, remind, record, control, or perform any necessary task to carry out a prescription, remind a user to do so, track activities, results, or both, and log information from prescription updates to user activities, to parametric values representing results of such execution of an exercise prescription. There exist today many formats, in hardware and software, for portable devices. More, and novel systems are to be expected.

In terms of carrying out the prescription, any suitable degree of supervision, oversight, attendance, or the like may be used in accordance with the invention. For example, an individual may complete an exercise prescription at home. Alternatively, such exercise prescription may be completed at a commercial gym, a doctor's office, a therapist's facility, a treatment facility, physical therapy center, exercise prescription center, or even in a class setting at any such center. Thus, the computer systems and exercise devices at such a center may log the attendance, activities, or both. Attendance and activity may be otherwise verified, the data collected, and reported electronically from the center.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefor, not to be considered limiting of its scope, the invention will be described with additional specificity and detail through use of the accompanying drawings in which:

FIG. 1 is a schematic block diagram of a computer system for implementing software, hardware, and interactions in accordance with the invention;

FIG. 2 is a schematic diagram of one embodiment of a process for implementing a system in accordance with an invention;

FIG. 3 is a schematic diagram of interactions and various computer systems interacting in a system in accordance with the invention;

FIG. 4 is a schematic block diagram of principal computer systems and their software modules for interacting with one another in order to implement exercise prescriptions in accordance with the invention;

FIG. 5 is a schematic block diagram of a memory system, which may be implemented in one or more memory devices for implementing software modules in accordance with the invention;

FIG. 6 is a schematic block diagram of a process for operating a system in accordance with the invention on a networked system of computers;

FIG. 7 is a schematic block diagram of various software modules in one embodiment of an implementation of an exercise prescription system in accordance with the invention;

FIG. 8 is a screen illustrating the control buttons for implementing the software modules of FIG. 7;

FIG. 9 is a computer screen view of a health status interface for implementing a system in accordance with the invention;

FIG. 10 is a computer screen view of an exercise prescription selection interface and a professional selection interface for implementing a system in accordance with the invention;

FIG. 11 is a screen shot of one embodiment of a patient medical history abbreviated to include key factors relevant to implementing an exercise prescription a system in accordance with the invention; and

FIG. 12 is a schematic block diagram of an assessment module for providing feedback in a system in accordance with the invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

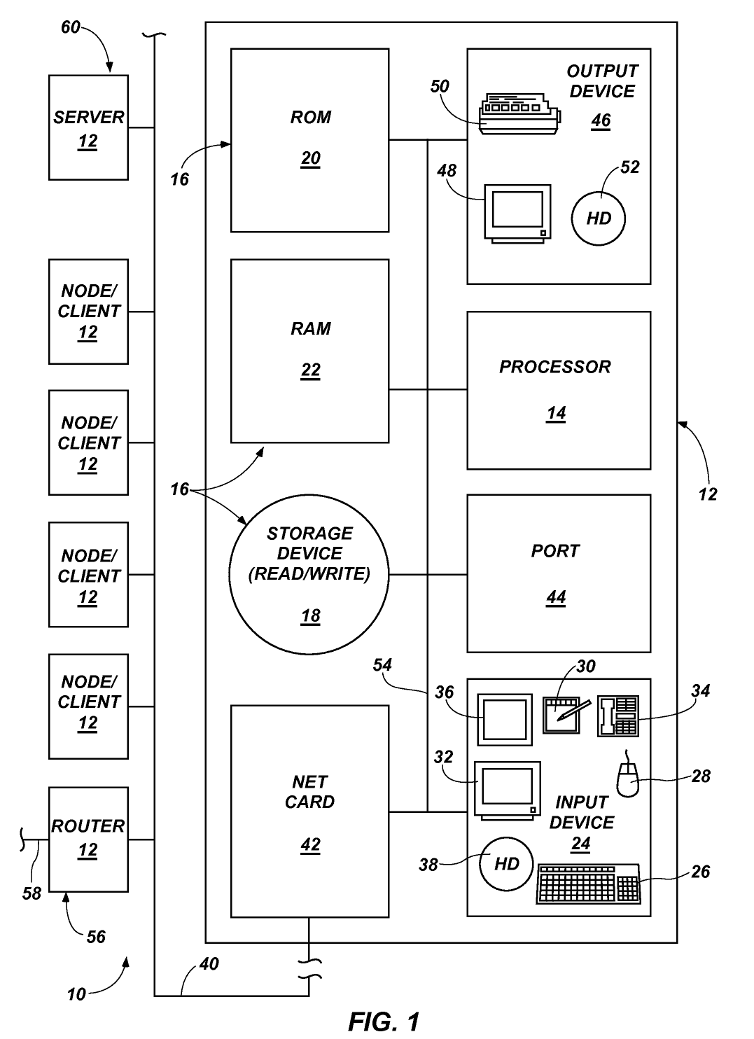

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

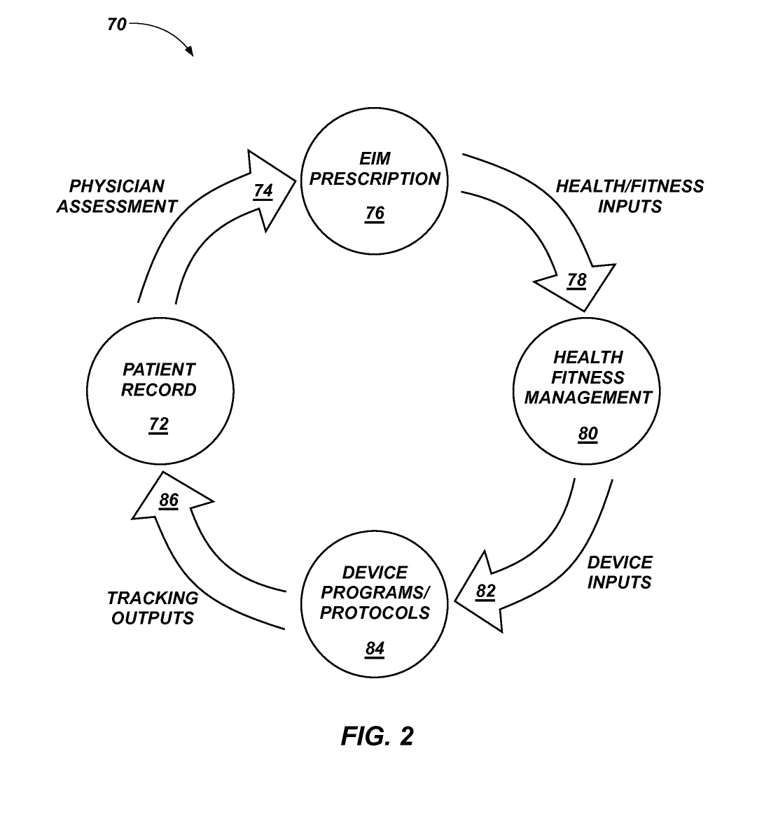

Referring to FIG. 2, a process 70 in accordance with the invention may begin with a patient record 72. A patient record 72 may include any or all of the information in a patient's medical history. Typically, a patient record 72 may be maintained by any particular physician who is a primary care physician, or a specialist, who has ever had an interaction for treatment, diagnosis, assessment, or the like with respect to any particular patient.

In the illustrated embodiment, the patient record 72 is an electronic record that is maintained in a database, may be derived from conventional patient records. Thus, a patient record 72 is transportable, accessible, database-compatible, and so forth. In certain embodiments, such a patient record 72 may also include an abbreviated record, and various mechanisms for selecting only certain abbreviated portions thereof.

For example, certain conditions that may provide or increase risks of exercise may be of particular importance. Similarly, certain symptoms may be indicative of exercise-related problems. Moreover, prescription medications, other health issues, and the like may be selected as a subset of an abbreviated portion of a patient record 72 in accordance with the invention. Typical, are cardio-vascular risk factors, ranging from age, to test conditions involving blood pressure, blood constituents, and the like.

A physician assessment 74 is a process by which a physician will consult with a patient, possibly conduct a physical examination, or simply review a patient record 72. Accordingly, a physician assessment 74 may result in a prescription 76. In the illustrated embodiment, a prescription 76 is associated with an “exercise is medicine” or “EIM” process in which an exercise regimen is implemented, including one or more of development, recommendation, communication, execution, tracking, feedback, assessment, and so forth. In the illustrated embodiment, a prescription 76 is best thought of as a doctor's order for execution of certain exercise regimens for a patient.

Inputs 78 may be thought of as health and fitness professional recommendations. That is, a physician, having created a prescription 76 also provides inputs 78 selecting particular health centers, physical exercise or rehabilitation facilities, centers for wellness or fitness, or the like. Along with those inputs 78 may be included a recommendation, explicit or implicit, of a specific health or fitness professional such as a physical fitness trainer, or specialist in, for example, cardio-vascular exercise, orthopedic rehabilitation, or the like associated with a condition on which the treatment by the prescription 76 is based.

Accordingly, health and fitness management 80 or a management computer, health or fitness professionals, health center, wellness center, or the like may be represented by the health and fitness management 80. Accordingly, certain software, computer systems, and professionals provide inputs 82 to devices.

For example, device inputs 82 may be instructions, selections, codes, or other identifying data that will control a machine or a series of machines in executing certain protocols. The device inputs 82 are forwarded to device programs 84, device protocols 84, or the like.

The inputs 82 may constitute abbreviated codes that implement specific programs 84 that are configured in accordance therewith, or even preprogrammed into exercise devices. Those exercise devices, will operate in accordance with programs, protocols, and so forth as selected, specified, programmed, dictated, or otherwise controlled by the device inputs 82.

Tracking 86 of health metrics such as blood pressure, heart rate, calorie expenditure, times, speeds, and other measurable parameters may indicate the efficacy, side effects, completeness, or the like of the execution by a patient of a particular protocol 84 or regimen 84 on a particular device. Thus, tracking 86 may be valuable in providing feedback to a physician in a subsequent physician assessment 74. It may appear or affect ultimately as an input 78 to health and fitness management 80. Again, the health and fitness manager 80 may be constituted by a system of computers corresponding to individual health and fitness professionals, health and fitness centers, both, or any combination or subcombination thereof.

In the illustrated embodiment, the tracking 86 ultimately results in additional information passed to the patient record 72. This is one reason why patient records 72 may appropriately be summarized, filtered, sorted, and the like, in order to provide properly prescribed information efficiently to the professionals 80 in the health and fitness field, or a physician responsible for an assessment 74. Likewise, the patient record 72 may also be accessed appropriately by a patient in order to obtain feedback, motivation, and so forth.

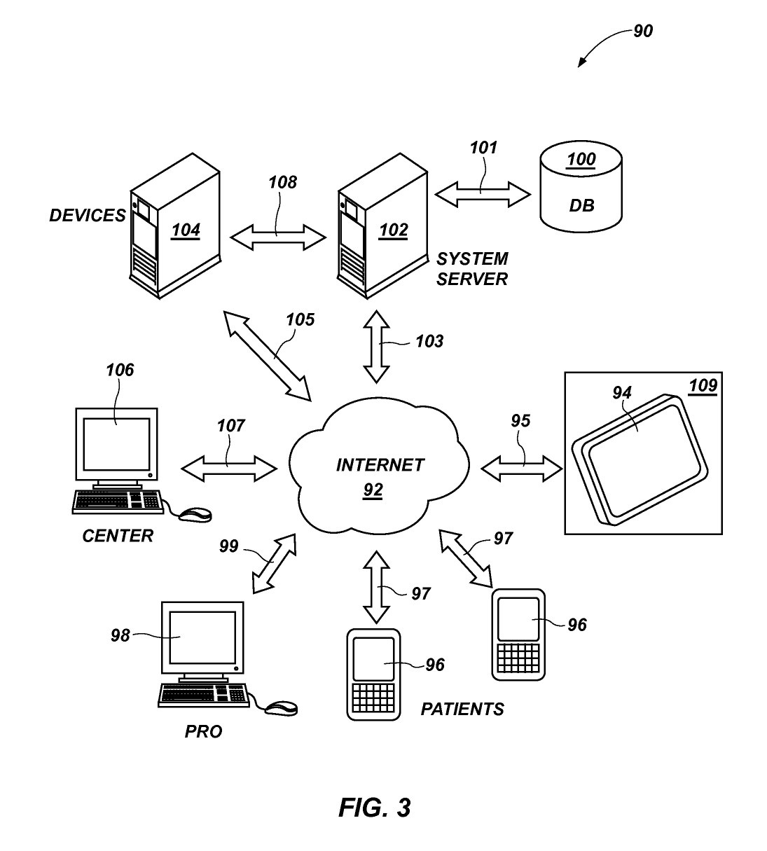

Referring to FIG. 3, a system 90 of computers 10 may be interconnected over an internetwork 92 such as the Internet 92. In the illustrated embodiment, one may think of the physician computer 94 as representing a physician 94 in the system 70, as well as the system 90. Likewise, one may think of the communication 95 as representing interactions between the physician 94, by way of the computer 94. Thus, one may speak of the physician computer 94, or the physician 94, generating and receiving communications 95 over the Internet 92. One may herein refer to any computer and its related entity by a single, joint reference numeral.

Likewise, a patient device 96, such as a smart phone, laptop, tablet, personal digital assistant (PDA), other computer, or the like may be thought of as the patient 96 as represented in the system 90 by the particular device 96 relied upon. In the illustrated embodiment, a smart phone 96 is illustrated. Nevertheless, a laptop 96, tablet 96, desktop computer 96, phone 96, or the like may be relied upon. Similarly, communications 97 by patient 96 over the Internet 92 may be implemented through the device 96.

A professional device 98 may be thought of as a computer 98 relied upon by a heath, fitness, or similar professional 98 receiving and implementing a prescription through electronic access over the Internet 92 in the system 90. In the illustrated embodiment, communications 99 by the professional device 98 may be used to send and receive information and instructions related to a prescription 76 associated with a patient record 72.

Notwithstanding the professional computer 98 as illustrated as a desktop type of computer, in general, a professional 98 may be connected to the Internet 92 through a series of servers 60, routers 58, personal devices 12, and the like. Accordingly, the professional computer 98 may be implemented in a laptop 98, personal digital assistant (PDA) 98, tablet 98, smart phone 98, or the like. In certain embodiments, the professional computer 98 may simply be implemented as a console hosted on some software platform acting as an input and output device connected to a server controlling various devices being used in an exercise regimen directed by the professional 98.

A database 100 may be maintained and may pass communications 101 to a server 102 implementing the system 90. In the illustrated embodiment, the system 102 may communicate directly to the database 100. Typically, a database 100 may be implemented in software and contain various records that are actually resident in a particular memory device 16 on the server 102. Thus, in certain embodiment, the system server 102 may actually be the hardware system responsible for maintaining and searching the database 100.

In certain embodiments, any or all software modules accessed by any device in the system 90 may actually be operated or executed on a processor in the server 102. In another embodiment, applications or apps may be installed in various devices 94, 96, 98, 104, 106 to interact most efficiently with the server 102, in order to access the database 100 and so forth.

In other embodiments, major portions of processing may be done by remote devices 94, 96, 98, and the like, thus minimizing traffic over the Internet 92 and minimizing the actual remote activities executed over the server 102. In general, servers 102 may be sufficiently fast to execute all processing. However, communication bandwidth considerations for remote locations across the Internet 92 may militate for implementing on the server 102 those tasks best accomplished on the server 102, while leaving to the individual remote devices 94, 96, 98, 104, 106 their particular tasks best suited for local processing.

As a general proposition, physicians 94 may typically be affiliated with a particular practice 109. One may think of a physician 94, or a practice 109 operating to conduct the medical professional assessment 74, develop a prescription 76, and create inputs 78.

In a similar way, many health and fitness professionals 98 are affiliated with centers 106. Thus, one may think of a center 106 as a computer 106 associated with, controlled by, and relied upon by a health or fitness center 106 that is affiliated with a number of professionals 98, and, typically, various devices 104.

For example, a center 106 may be a health center, a rehabilitation center 106 within a hospital, a gym 106, a facility 106 operated by a physical therapist, or the like. Thus, communications 107 with a center 106 may actually be destined to be received by a professional 98 affiliated with the center 106. Likewise, independent professionals 98 may coordinate with a center 106, or may operate independently therefrom.

In many embodiments, the centers 106 are simply specific facilities associated with a hospital and thus accessible to numerous physicians 94. Physician 94, may have relationships with those hospitals and therefor have access to their affiliated wellness or fitness centers 106 or rehabilitation centers 106.

Devices 104 may physically be present at the same facility associated with a center 106 computer. Accordingly, such devices 104 may communicate 105 over the Internet 92 to the computers 106 of the center, and the computers 98 of professionals. Iin certain embodiments, the devices 104, may be thought of as the entire devices 104 or computers 104 within devices, such as treadmills, exercise bicycles, rowing machines, cardio-vascular exercise devices, strength training equipment, and the like. All may be computerized, network aware, and thus able to pass communications 105 or exchange communications 105 over a wireless connection. This may occur locally, through a local area network, through a wide area network, or over the Internet 92.

Accordingly, the devices 104 may be controlled by the center 106 or the professional 98. In other embodiments, much of the content, including updated programs, options, and the like, may be transferred by direct communication 108 with the system server 102. For example, for security or other purposes, devices 104 may operate through system servers 102 in a center 106, or the system server 102 of the overall system 90.

Nevertheless, it has sometimes been found effective to operate devices 105 by communications 105 executed by individual patients 96 in their homes. A device 104 may be a personal device 104. Centers 106 may have many types and instances of devices 104 as part and parcel of the facilities in a center 106. Thus, the device 104 may be directly connected to a center computer 106, just as illustrated with respect to a system server 102. A system server 102 may actually be affiliated with a medical practice, a fitness center, or the like.

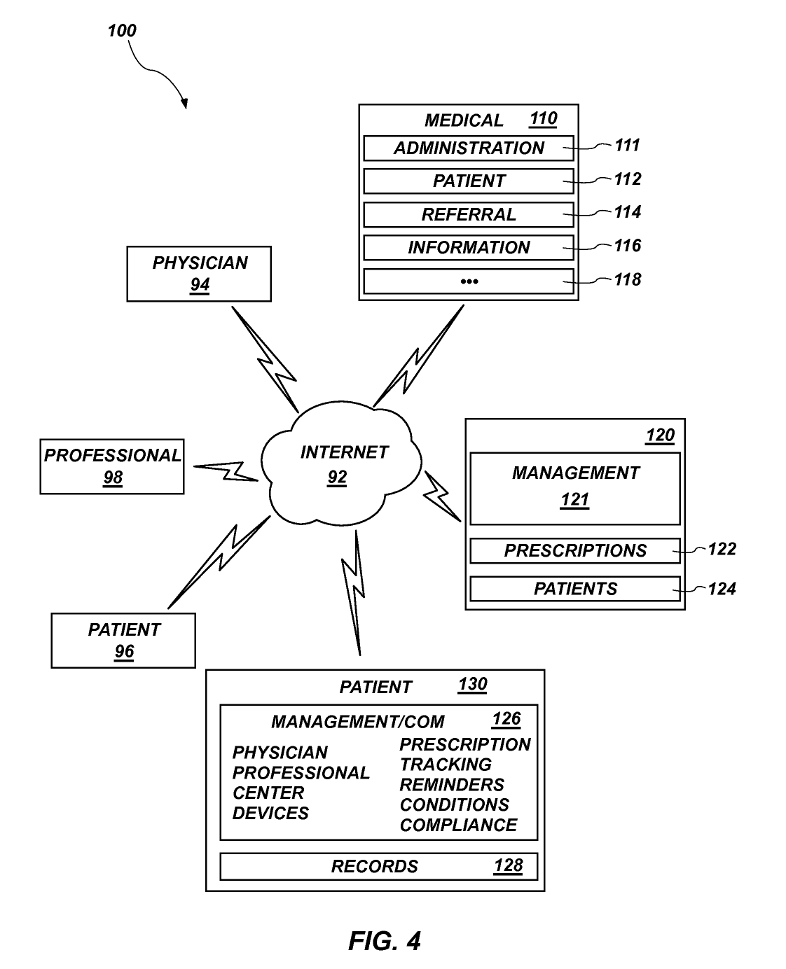

Referring to FIG. 4, while continuing to refer generally to FIGS. 1-12, a physician 94 or physician computer 94, a health and fitness professional 98 or professional computer 98, and a patient computer 96, or computing device 96 corresponding to a patient 96 may operably connect to one another and a database 100 through the Internet 92.

In the illustrated embodiment, the computers 94, 96, 98 may execute certain applications 110, 120, 130, or modules 110, 120, 130. In certain embodiments, the applications 110, 120, 130 may be downloaded to their respective devices 94, 98, 96. In other embodiments, the software modules 110, 120, 130 may be executed on a server 102, and simply accessed through a smaller application on the individual devices 94, 98, 96 of the respective individuals.

A medical module 110 may be responsible for functioning to accomplish the responsibilities of a medical professional 94. An administrative module 111 may address administrative requirements such as logging on, security, access control, and the like. Likewise, identification, accounting, scheduling, and so forth may also be the responsibility of an administrative module 111.

Similarly, a patient module 112 may be responsible to provide an interface to patient information, or to patients directly. Thus, a patient module 112 may be responsible for selecting a patient, documenting assessments 74 by a physician, selection of a particular one or more conditions to be treated by the medium of exercise, and so forth. Thus, a patient module 112 may provide numerous functional requirements for a physician 94.

Again, herein, it is proper to speak of the computing device 94 of a physician 94, or the physician 94 himself or herself by the same designation. That is, in a system 70 and a hardware system 90 in accordance with the invention, human beings are known to a computer system 90 by their computers 12. Thus, it is proper to speak of any entity hereinafter or within this description by the same numeric designation as the computer representing that entity.

A referral module 114 may be responsible for identification of a particular health or fitness professional 98, by individual, or by center 106. Likewise, the referral module 114 may be responsible for searching, sorting, filtering, selecting, communicating, and otherwise interacting with information maintained in the database 100. Other data may be associated with a particular fitness or health professional 98, or affiliated center 106. Likewise, the referral module 114 may be responsible to communicate information to, about, from, or the like any such health professional 98, or center 106 directly, as well as communicating such information with a database 100.

An information module 116 may provide to a medical professional 94 information that will be helpful for any number of reasons. For example, data for interfacing with the system 90, in order to implement the process or system 70, may be provided. Similarly, help files, frequently asked questions, operational instructions, and detailed information about the utility or efficacy of particular exercises, devices, or the like may be provided.

Notwithstanding the referral module 114 may provide the information and details about particular health or fitness professionals 98, the information module 116 may provide searches, reviews, patient feedback, or the like. Typically, the information module 116 may be thought of as elective or useful information, as opposed to the required management and access control information that may be within the principal purview of the administrator module 111.

Other modules 118 may be implemented in the medical module 110. Again, those other modules 118 may be client-server modules, login and logout modules, coordination modules, other communication modules, or the like. Other modules 118 may include downloading functions, uploading functions, micro applications, downloadable applications for implementing the medical module 110 on a remote device such as a PDA, smart phone, tablet, or the like, and so forth.

A health and fitness module 120 may include a management module 121 responsible for various management functions. For example, administrative functions may be implemented therein. Likewise, various equipment management, scheduling, communications, and so forth with devices 104, professionals 98, to and from the center 106, or with respect to patients 96 or physicians 94 may be implemented in a management module 121. A management module 121 as illustrated herein may be implemented to handle the center 106 with its administrative procedures, intake, release, and other administrative functions.

Prescriptions 122 and patients 124 or prescription modules 122 and patient modules 124 are called out individually. For example, in the illustrated embodiment, a principal significance of the health and fitness module 120 is the use thereby of the prescription module 122 and patient module 124. The prescription module 122 may be thought of as the substantive executables for handling the intake, execution, tracking, reporting, and other functionality with respect to a prescription 76 received as an input 78 from a medical professional 94 (e.g. physician 94). The health and fitness management 80 as represented by an individual professional 98 or the center 106 has need of the executables in the prescription module 122 in order to receive, find, implement, and report on the status of prescriptions 76 applied to patients 96. Similarly, a patient module 124 may be thought of as the system of executables responsible for interacting with a patient 96, patient computing device 96, patient information and so forth. In the illustrated embodiment, the significance of a health and fitness module 120 interfacing with a patient module 130 is illustrated.

A patient module 130 may include a management module 126. Again, the patient module 130 may be hosted on the server 102, or within an individual device 96 corresponding to a patient 96. Similarly, in a client-server type of model, a portion of the patient module 130 may be implemented in the remote device 96, of a patient 96, and a portion may be implemented in the server 102. Regardless of architecture, a management module 126 may be thought of as the executables 126 or system 126 of executables that will communicate, coordinate, schedule, control, login, logout, download, upload, and otherwise perform all the management functions necessary for a patient 96 to interact within the system 90, in accordance with process 70 or system 70.

In the illustrated embodiment, the patient module 130 may be responsible to operate through a module 126 or some submodule thereof to interact with a center 106, or a particular device 104. Again, by device 104 is meant both a computerized processor or the like that may be thought of as a computer 104 in a particular piece of exercise equipment 104, as well as the device 104 (entity 104) itself.

Certain aspects of the management module 126, including data, select executables, and the like may be implemented in various forms in order to simplify interactions between a patient 96 and an exercise device 104. For example, in certain embodiments, a device 104 may be connected directly to a computer 102 owned by a user. In such an embodiment, the user may interact directly with a device, or interact by any connection means available. Connection means may be wireless, wireless direct, wireless networks, Internet connections, or the like. Nevertheless, interactions with devices may be thought of as part of the overhead or management module 126 of a patient module 130.

A principal element of a patient module 130 is a records module 128. Thus, conventional or routine management functions, as well as many of the functions implemented in the systems 70, 90 may rely on the records module 128. For example, to the systems 70, 90, a patient 96 is represented by a patient record 72. Thus, a records module 128 may be responsible to receive, implement, communicate with, report on, or the like a prescription 76, tracking of operation of a device 104 during execution of that prescription 76, providing reminders to a patient 96, a physician 94, and exercise or fitness professional 98, or the like.

Likewise, the records module 128 may be responsible to receive information on patient condition, flag updates that may bear on an assessment of that condition, track times, dates, durations, intensities, and other characteristics associated with execution of a prescription 76, and the like. Thus, to the systems 70, 90, the records module 128 within the patient module 130 may be a significant, substantive element in effecting a prescription 76 and obtaining suitable updates to patient records 72 in order for assessments 74 to be timely, accurate, and so forth.

Similarly, interventions or responses to conditions of a patient will necessarily benefit from the records module 128 performing the foregoing functions.

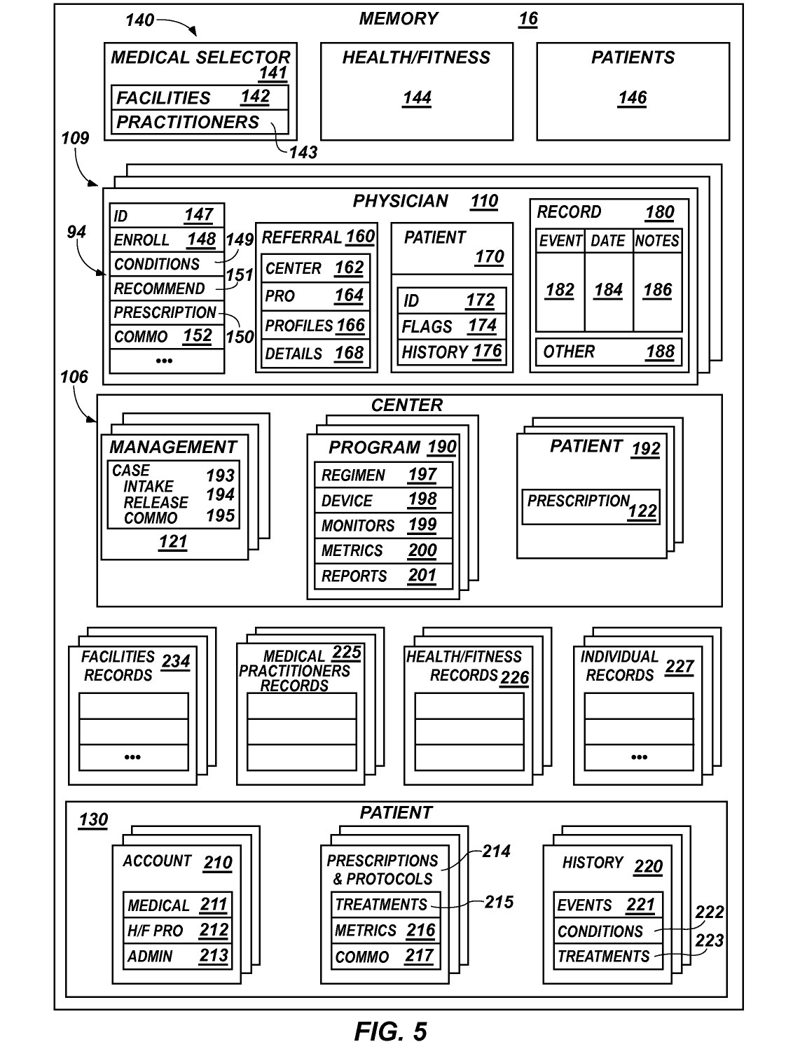

Referring to FIG. 5, while continuing to refer generally to FIGS. 1-12, a memory device 16, may be implemented in one or more memory devices 16 in one or more computers 12 in a system 10 connected within a system 70, 90. For example, at any particular time, any particular device 94, 96, 98, 102, 104, 106 may be operating on particular data.

Certain executables may be resident and executing in any particular CPU in any particular device 94, 96, 98, 102, 104, 106. Meanwhile, at some point, data is uploaded to be processed by the server 102, and eventually stored in a database 100. Thus, one may think of a system 140 or array 140 as a collection 140 of records 140 or modules 140 responsible to manage those records.

Without being redundant, one may speak of software modules 140 as a collection 140 of executables operable on one or more processors within a system 10, 70, 90. Alternatively, one may think of a collection 140 of records 140 as the non-executable data that is relied upon by executable modules. Thus, it is proper to refer by the reference numerals to a particular module 140 as an executable 140, or as the record 140 that forms a principal object of such an executable.

In the illustrated embodiment, a medical selector 141 may be responsible to select facilities, practitioners, or the like. In the illustrated embodiment, one may think of a facilities selector 142 as a selector 142 responsible for filtering, sorting, searching, or otherwise selecting a particular medical facility. Similarly, a practitioner selector 143 may be similarly applicable to a medical practitioner, such as a medical doctor 94, a practice 109, both, or either. Similarly, one may think of the facilities 142 selected, or the practitioners 143 selected by the same designation.

A medical selector 141 may typically be thought of as being of practical value to a patient 96. A patient 96 may seek a medical professional 94 in order to provide an assessment 74, treatment, or the like.

A health and fitness selector 144 may be thought of as the executables 144 relied upon by a physician 94 in order to select a particular health or fitness professional 98. Again, a professional 98 may be designated individually, or by a center 106 with which a professional 98 is affiliated. Either may be selected. By either mode, the health and fitness selector 144 may be responsible for executing the processes required to present, sort, filter, provide information regarding, and otherwise assist in selection of a professional 98, center 106, or both.

A patient selector 146 may be responsible for assisting a physician 94 in identifying a patient. For example, upon receipt of a new intake of a patient 96, a physician will typically access current patient records 72. A physician 94 may also create a new patient record 72.

For example, if a patient 96 is not yet within a system 70, 90, a physician may need to provide certain information to a patient 96, requesting and enabling the patient 96 to update a patient record 72, or create a patient record 72 suitable for access by the systems 70, 90 and the database 100.

Likewise, upon receipt of a prescription 76, a health or fitness professional 98 may need to locate a patient 96, corresponding to a prescription 76. In writing a prescription 76 for exercise, a physician 94 will necessarily need to draw from a database 100 containing records 72 corresponding to individual patients 96. Thus, the patient selector 146 may be thought of as one or more executables 146 for use by a physician 94, a health or fitness professional 98, either, or both.

In the illustrated embodiment, the medical selector 141, health and fitness selector 144, patient selector 146, and the like may serve to upload or access information authorized for delivery to an appropriate party. For example, certain details associated with physicians 94, patients 96, and health and fitness professionals 98 are now publicly available. Particularly of concern are relationships between such 94, 96, 98.

Certainly protected are patient records 72. Nevertheless, a medical module 110 may include an identifier module 147 that may rely on the patient selector 146. Likewise, an enrollment module 148 may execute the functionality required to enroll a patient 96, by a physician 94, in the system 70. Similarly, a condition module 149 may assist in identifying and selecting a particular, chronic condition to which a patient 96 is subject, and which is to be treated by an exercise prescription 76.

A prescription module 150 may assist a physician in creating a prescription 76. To that end, a recommendation module 151 may recommend to a physician a particular exercise regimen, by way of a recommended prescription 76, which a physician 94 is then at liberty to assess, modify, accept, reject, or the like.

A communication module 152 may be responsible to communicate to a patient 96, a health and fitness professional 98, and most likely to both, a prescription 76 provided by the prescription module 150. Thus, by a minimal time commitment, the medical module 110 may quickly assist a physician in identifying a patient 96, uploading necessary information, editing that information and minimizing it to a set sufficient to be clear, and insufficient to confuse or overburden a physician 94. Thereby, a communication module 152 may effect communications rapidly, effectively, and accurately.

In the illustrated embodiment, a referral module 160 or referral selector 160 may include a center module 162 to present information, and assist in selection of a center 106 to which to refer a patient 96. Similarly, a professional selector 164 may be used as part of the center selector 162, or independently therefrom. That is, a health and fitness professional 98 may or may not be associated with a center 106. Thus, a referral module 160 or referral selector 160 may support a center module 162 for selecting a center 106, a professional module 164 for selecting a professional 98, either, or both.

As an assistance to a physician 94, a profile module 166 may permit browsing across information publically available regarding professionals 98, centers 106, and the like. Thus, the profile module 166 may assist a physician in choosing a new professional 98, changing, or browsing, for standard or even for novel conditions that have not been regularly referred previously.

For the same reasons, a details module 168 may provide for searching, uploading from the database 100, or the like, in order to provide additional details. For example, a profiles module 166 will typically be as abbreviated as necessary to be effective and efficient. Nevertheless, in certain circumstances, where time is available, a physician 94 may need, or even require, additional assistance from a details module 168.

A patient module 170 may operate in conjunction with other modules with an identification module 172 responsible to affirmatively identify a patient. A flags module 174 may present warnings, interaction advisories, and the like. For example, by having access to details of a patient record 72, a patient module 170 may create flags through the flags module 174, may upload through a history module 176, any aspect of the history, or a sorted, filtered, or particularly identified aspect of a patient record 72, or the like. Thus, a patient module 170 may be responsible for rapid access to key information pertinent to an exercise prescription 76, or which may be consistent or inconsistent with such a prescription 76.

Meanwhile, a records module 180 may be responsible for providing in a standardized format, in the illustrated embodiment, certain, selected, standardized, record data 180 that will be most useful. For example, certain information may be highlighted. Typically, of interest to a physician, may be various events 182, whether those events 182 be accidents, illnesses, or treatments. Information may include dates 184 associated with those events 182, and any notes 186 by an attending physician, by a patient, or by a system 70, 90 processing such information. Meanwhile, other modules 188 may be available in the records module 180 in order to access or upload key information associated with patient records 72.

A center module 120 may include a management module 121 to effect such process as an intake step 193 involving obtaining information necessary to induct a patient 96 into the procedures and patient roster of a center 106. Of course, a center 106, may be an individual professional 98. Meanwhile, a release module 194 may be responsible for executing all those functions necessary to release a patient and close out a prescription 76 for a particular patient 96. The release module 194 may include the interlocks and safety mechanisms to ensure that exercise regimens according to a prescription 76 have been properly executed, completely executed, and lack any untoward or unexpected consequences that should be reported back.

Meanwhile, a communication module 195 may be responsible for providing communication associated with case management.

A programs module 190 and a patient module 192 may be part of a center module 120. In the illustrated embodiment, a programs module 190 may actually have a program selector 196. Thus, a professional 98 may be able to select a particular program for implementing on a particular device 104. In many instances, multiple devices 104 will be used at different times, in order to thoroughly exercise, rehabilitate, assess, repair, or otherwise assist a patient 96 in recovery, rehabilitation, or the like. Accordingly, a devices module 198 may be responsible for selecting devices, and may also include responsibility for scheduling with devices recommended or otherwise selected by a physician 94, or professional 98.

A monitor module 199 may be responsible for tracking the parameters deemed important by the professional 98, physician 94, or as specified in the prescription 76. Accordingly, certain metrics may be managed by a metrics module 200, responsible for selecting, processing, and otherwise assisting in the monitoring 199 of particular metrics associated with a patient 96.

For example, a metrics module 200 may conduct processing, graphing, comparisons, setting of flags and limits, and so forth. Meanwhile, the monitor module 199 may be principally responsible for collecting the information. Typically, a metrics module 200 may have the responsibility for actually processing the data of the monitor module 199 to provide meaningful information, such as charts, graphs, comparisons, and the like.

A reports module 201 may be responsible for reporting raw data from the monitor's module 199, process data and its representation in graphical or visual forms by the metrics module 200, and the like.

The patients module 192 may include functionality to identify, manage, and otherwise deal with a prescription 76 for a particular patient 96. A prescription module 122 may be partly or wholly responsible for that interaction. Thus, a prescription module 122 may be an executable or a system of executables 122 effective to identify, track, and otherwise relate prescriptions 76 to the patient 96.

A patients module 130 may include an accounts module 210. The accounts module may include, for example, a medical account 211. A medical account 211 may correspond to a medical professional 94 such as a physician 94. The medical account module 211 is responsible for managing the account, including access, and the like for a medical professional 94. Similarly, a professional module 212 is responsible for the management of the professional account of a health or fitness professional 98. An administrative module 213 may be responsible for other administrative functions in managing accounts.

Typically, a patient account module 210 is responsible for managing the patient's account in the systems 70, 90, and providing a suitable access. A medical module 211, professional module 212, and administrative module 213 will assist the individual patient 96 in interfacing with those other entities 211, 212, 213. Meanwhile, a prescription module 214 may include a treatments module 215, that actually contains the data from a prescription 76, as well as corresponding information associated with that particular prescription 76.

For example, various information about a physician 94, a professional 98, a center 106, the devices 104, and records corresponding thereto may be accessed by a treatment module 215. Similarly, a metrics module 216, may be responsible for obtaining, sorting, filtering, and otherwise relating information back and forth between a patient 96, and the database 100, regarding a patient record 72. Meanwhile, a communication module 217 may be responsible principally for receiving and exchanging communications quickly, typically according to pre-planned, and templated, reports to and from physicians 94, professionals 98, centers 106, and the database 100.

A history module 220 may include an events module 221, a conditions module 222, and a treatments module 223. Typically, the history 220 may be thought of as selecting, keeping, or serving up details of the record 72, identifying each selected, significant event, by way of treatment, discovery, or onset. For example, events 221 may typically be diagnoses, illnesses, surgeries, accidents, and the like. Meanwhile, conditions 222 may be thought of as chronic conditions existing, or long-term conditions existing, as a result of events 221. They are typically affiliated with or associated with the systems 70, 90.

Similarly, treatments 223 may be thought of as information principally used by and connected with the systems 70, 90. Nevertheless, treatments 223 may include events 221 as curative or ameliorative events. Thus, the events module 221, conditions module 222, and treatments module 223 may be responsible to provide such information and selections from the history 220 for rapid access. Filtering, sorting, arranging, and otherwise relating key information related to exercise prescriptions 76 may be principal.

Other modules 224, 225, 226, 227 may be available for access with proper authorization. For example, facilities records 224 may assist in managing, accessing, filtering, sorting, and otherwise browsing, or accessing facilities records 224 that are authorized. Meanwhile, practitioner records 225 or medical records 225 may relate to medical professionals 94. Similarly, health and fitness records 226 may relate to centers 106, as well as individual professionals 98. Individual records 227 or individual records module 227 may assist in accessing selected information.

Thus, different individuals with different relationships may have access according to certain privacy controls and need to know through a facilities records module 224, a medical practitioner records module 225, a health and fitness records module 226, and an individual patient records module 227.

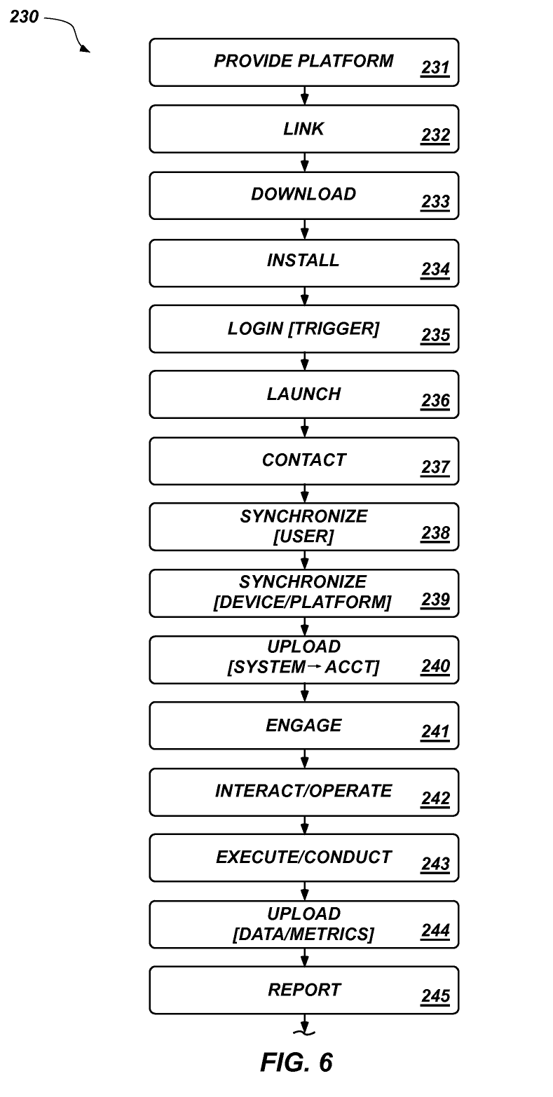

Referring to FIG. 6, a process 230 may be implemented in one embodiment in accordance with the invention to assist in implementing the systems 70, 90. In one embodiment, providing 231a mobile platform may be the responsibility of an individual patient 96, or a medical professional 94. In other embodiments, a professional 98 or facility 106 may provide 231a mobile platform for use by a user.

For example, an individual may use a smart phone, a laptop, computer tablet, or the like in order to interact over the Internet 92 with a professional 98 and a set of devices 104 in order to implement a prescription 76. In other embodiments, a center 106 may provide a dedicated device as a platform for a particular patient 96 to interact with various devices 104 while executing a regimen in accordance with the prescription 76.

Linking 232 the platform, which effectively becomes a patient computer 96, may involve logging on to a system, network, Internet 92, or the like. Eventually, a user may download 233 an application. The application may include any or all of the modules described hereinabove in order to implement the prescription 76. Installing 234 may occur immediately or at some time following downloading 233 of the application.

Typically, a user will begin by logging in 235. In some embodiments, the physical connection of a device 96, or the network connection thereof may trigger a login 235 automatically. Ultimately, either automatically, or in response to a selection by a user, launching 236 the application may occur. Typically, a system will contact 237 the server 102 in order to exchange necessary information coordinating a patient 96 with the physician 94, prescription 76, professional 98, center 106, and devices 104, or any combination or subcombination thereof.

A synchronization 238 of the particular platform 96 with the systems 70, 90 will typically involve accessing the database 100 to the server 102. Accordingly, information, such as patient records 72 and the prescription 76 will be key information. At or after this time, a particular device 104 may be identified, contacted, or synchronized.

Data synchronized may correspond to the patient 96 or patient platform 96 (computer 96) to begin implementation of the exercise prescription 76 including tracking, and so forth. Synchronization 239 of data may follow the initial synchronization 238 to the accounts of the various individuals and entitles that will be authorized and involved in the implementation of the prescription 76.

Uploading 240 may involve uploading from the systems 70, 90 to the devices 94, 96, 98, 106, 104 information required to effect the prescription 76. In certain embodiments, one may think of the uploading 240 as uploading by the system 102, typically from the database 100, information pertaining to a patient 96, patient records 72, and exercise prescription 76 a system of exercises, controls, items to be tracked, possibly any entertainment or other distracting events that will be occurring simultaneously with exercise, or the like.

Ultimately, engaging 241, by the patient computer 96, the server 102 and the system 90 begins implementation of the prescription. At that point, the necessary controls and other interacting 242 may occur. It is important to note here that all of the foregoing steps 231 through 241 of the process 230 may be implemented by a physician 94, a patient 96, a professional 98, a center 106, or a device 102. That is, each has a need, and a role in interacting 242 or operating in conjunction with the systems 70, 90. Accordingly, each may implement the same standard steps for which it is responsible on its own behalf in order to properly interact 242 with the systems 70, 90. Ultimately, conducting 243 a program, uploading 244 the suitable information, and reporting 245 where otherwise communicating 245 may then be done.

For example, in conducting 243 its particular portion of the program, a physician computer 94 will do something different than a patient computer 96. Similarly, a center computer 106, and professional computer 98 may interact differently with the systems 70, 90. Likewise, a device 104, brought online for the first time will act differently.

Meanwhile, a device 104 once operably connected, may operate to take its particular place in the systems 70, 90. Similarly, uploading 244 particular information, such as patient data from records 72 authorized for access, will be different for the physician 94, the patient 96, the professional 98, the center 106, and the device 104. Nevertheless, each may upload 244 data in accordance with its role, its collection, its decisions, its analyses, and so forth. Likewise, communicating 245 or reporting 245 will be a different function for each entity and its associated computer.

For example, various professionals may exist in various fields, a professional 98 may be selected from an athletic trainer in a particular sport or exercise type, a cardio-fitness specialist, or a rehabilitation specialist whose work is directed to rehabilitation of a particularly bodily member, function, structure, condition, or the like. Similarly, physical therapy, weight training, strength training, flexibility training, balance, specialist responsible therefor, and the like may be selected.

Meanwhile, various tools may be selected in order to measure, track, assess, compare, or otherwise provide data for processing and feedback and associate with execution of a prescription 76. In other embodiments, a user may be provided the opportunity to intervene. In certain selected embodiments, no user intervention may be required.

Similarly, various programs may be identified by codes, texts, icons, or the like to identify particular regimens, devices, frequency of exercise, intensity, and so forth. Also, durations, may be important and therefor selected. For strength training, typically, intensity is a function of the exercise protocol and therefor frequency, repetitions, and the like may be specified. Meanwhile, trackers for programs may also be implemented.

Similarly, the system may also provide wireless connections for tracking, evaluating, communicating prescriptions, and the like. A professional interaction may require downloading of a prescription, tracking progress to assure completion, instructions on which sensors or how much information to track, difficulties to watch for, developments to observe, and other evaluation processes may be specified by a physician 94. Meanwhile, instructions may be provided to a professional to limit exercise, to restrict exercise within certain limits, or to even unrestricted.

By the same token, patients 96 may be thought of as members serviced individually by a health or fitness center 106. Thus, the individual patient 96 may self select if operating solo a personal device not at a center 106. Meanwhile, a particular patient 96 may also self prescribe exercise according to information obtained through the systems 70, 90, or outside. In other embodiments, a patient 96 may simply receive a copy of a prescription 76, which prescription may have already been forwarded to a center 106, or individual professional 98 for implementation.

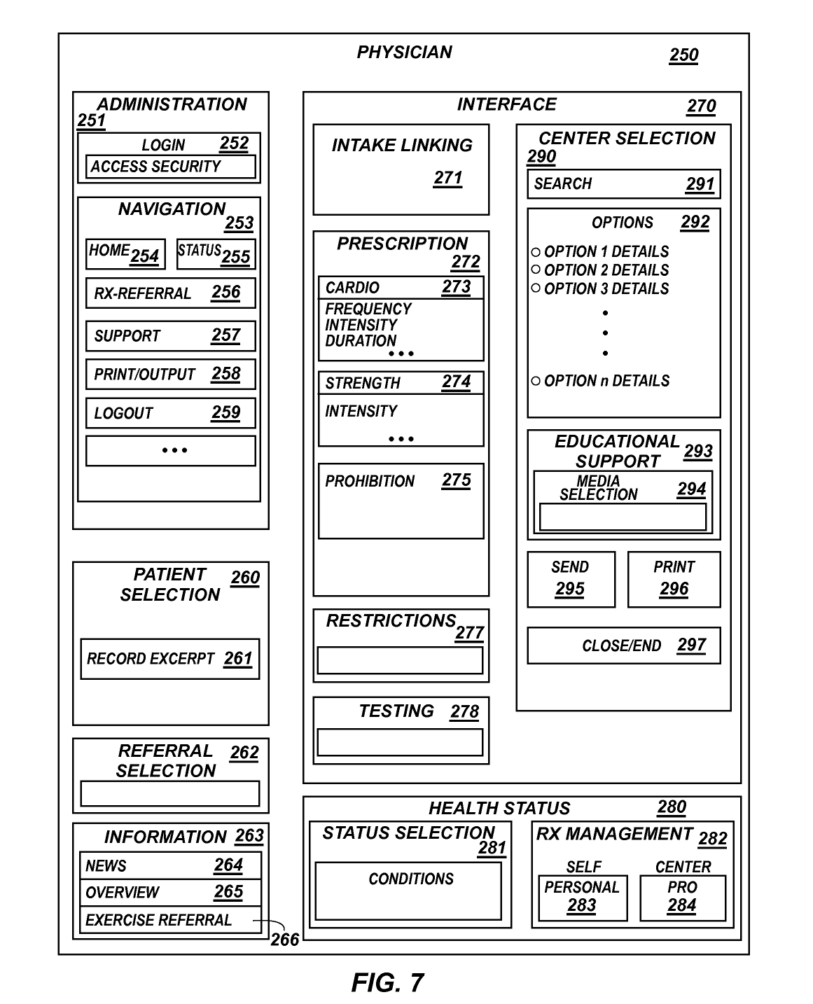

Referring to FIGS. 7 through 11, a physician interface 250 may be implemented in an executable module 250, or a graphical user interface 250. Both, in keeping with the convention established hereinabove are referred to by the same reference numerals. For example, a field, button, input line, dialogue box, or the like may have the same reference numeral as an executable module responsible to implement the functionality triggered by such an interface icon as a button, field, input line, and so forth.

A physician interface module 250 may include an administrative interface module 251. The interface module 251 may be responsible for login 252 including access control and the like. Similarly, navigation 253 may include access to a home 254 screen, a status 255 screen, a prescription and referral screen 256 or window 256, as well as support 257, logout 258, printing 259, and the like.

In the illustrated embodiment, a patient selection module 260 may be represented by a patient selection screen or window 260. Typically, a record excerpt 261 will be presented in order to minimize the time, reading, and interaction required by a physician 94. A referral selection module 262 may implement the selection by a physician 94 of a center 106, a professional 98 affiliated by that center 106, or both.

An information module 263 may provide access to news, overview 265 assistance or explanations required to implement an application in accordance with the invention, as well as a referral control 266. In the illustrated embodiment, a graphical user interface module 270 may provide for intake linking 271 on a home screen 254.

A health status module 280 may implement selection of the chronic condition of interest associated with an exercise prescription 76. Meanwhile, a center selection module 290 may implement selection, browsing, or other interactions to identify and communicate with a particular center 106 responsible for effecting a prescription 76.

Thus, a prescription module 272 may include an intensity module 273 responsible to receive an input identifying frequency, duration, and type of exercise. Similarly, a strength module 271 may identify a frequency, protocol, or the like for a strength training or rehabilitation. Similarly, a non-exercise module 271 may receive an input for suggesting that a patient is not prepared for exercise of a certain type, or of any type.

Various restrictions may be implemented in restriction module 276 which may include warnings. Meanwhile, a field 277 of text 277 may provide for descriptions. In other embodiments, specific restrictions may be identified such as no walking, no running, no exercises requiring balance, or the like.

The status module may have a selection module 281 having a limited number of conditions. That is, within about fifty basic conditions are included most health problems encountered. Within one hundred conditions are included virtually all commonly understood health conditions that represent chronic health maladies. Accordingly, a selection module 281 may enable a particular physician 94 to select very quickly from a standard list in a standard format a particular condition to be addressed by a prescription 76.

Likewise, a prescription management module 282 may also identify whether the exercise prescription 76 is to be implemented by the patient 96 himself or herself as a personal management 283, or under the direction of a center 106, professional 98, or both, as a professional management 284 selection.

A center selection module 290 may provide for a search 291. Typically, a particular identification such as a proximity to a hospital or a physician 94, proximity to a patient 96, or the like may be input, or obtained from the database 100. Accordingly, various options 292 may be presented and one may be selected to identify a particular center 106, professional 98, or both.

Any educational support 293 may be selected, such as by a document selector 294. Thus, additional information may be provided. Videos, YouTube™ tutorials, paper brochures, or the like may be provided electronically. Meanwhile, sending 295 such information to the responsible individuals, including professionals 98, centers 106, patients 96, or others may be selected. Printing 296 may provide a hard copy deliverable by a physician 94, such as at the time of an assessment 74, to a patient 96. Finally, a closing selection 292 may close out all information, close files, change access codes, and otherwise protect privacy, and integrity of procedures, records, and the like.

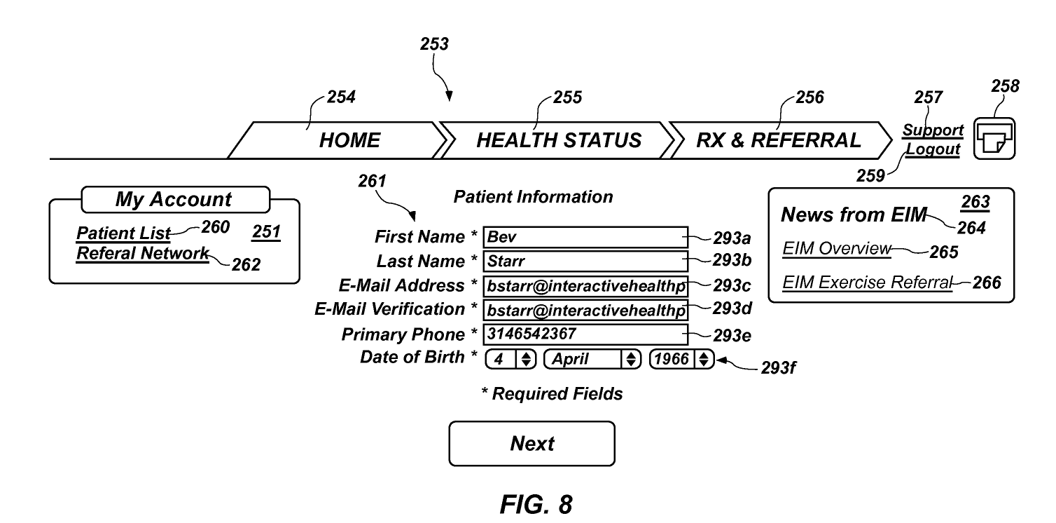

Referring to FIGS. 8 through 11, while continuing to refer to FIGS. 1-12, the record excerpt 261 may include various minimal fields 293 sufficient to identify with certainty a particular patient. For example, the fields 293a, 293b, 293c, 293d, 293e, 293f provide a first name, last name, email address, verification thereof, phone number, date of birth, respectively in order to positively identify a particular patient 96.

The information input by a physician 94 in the record excerpt 261 is selected to be sufficient to unmistakably identify a particular patient, without requiring significant time, and certainly not requiring independent references. For example, a first name, last name, or both may be input. The remaining information may be automatically uploaded from the database 100. Accordingly, a physician may thus correct or select any information by adding to that.

For example, a physician may begin with a last name, which will be insufficient to identify a patient, unless a single patient has that last name. Similarly, by adding a first name, the possible records may be narrowed. As soon as sufficient information is available to narrow a record, a record may be selected by the system 90 and presented in the excerpt 261. A physician 94 may alter data in order to change the excerpt 261. Behind the excerpt 261, the system 90 will have all information, available for processing, and for other purposes directly from the patient records 72 as saved in the database 100.

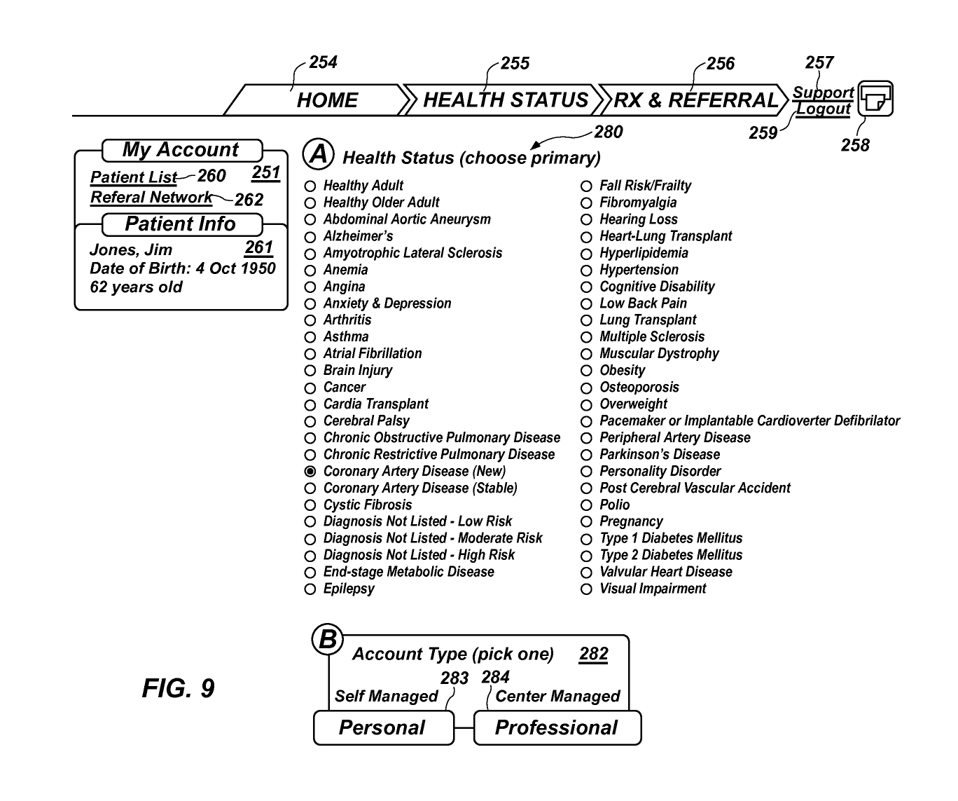

Referring to FIG. 9, while continuing to refer to FIGS. 7-11, a selection of the health status button 255 may shift control from a different button 254, 256 in order to provide a health status selection 280. The listing is typically in alphabetical order. It includes chronic conditions that are most common and that may be the subject of an exercise prescription 76.

In one presently contemplated embodiment, all conditions are shown in a single window, on a single screen, at a single time in order to provide instantaneous selection and access by a physician 94. Similarly, the account type 282 or the management module 282 may have the personal button 283 and professional button 284 available on the same screen in order to minimize the time, navigation, screen changes, reading, and the like that tend to take time.

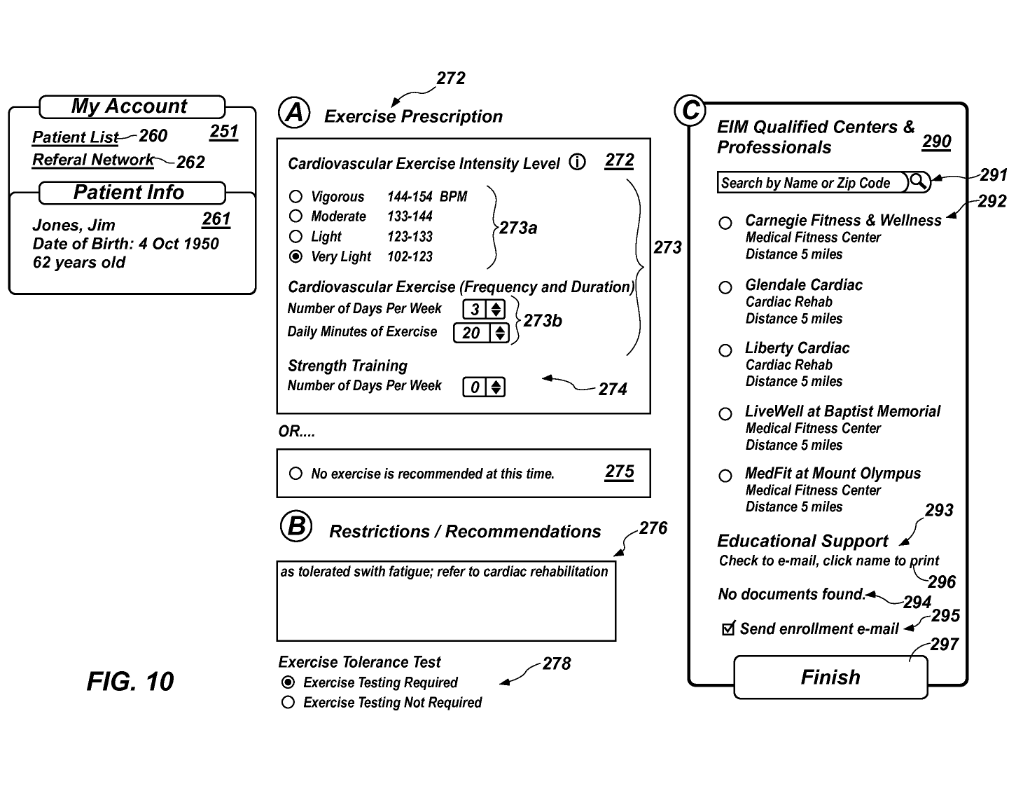

Referring to FIG. 10, while continuing to refer to FIGS. 7-11, the prescription module 272 provides an intensity designation 273 which may be qualitative in nature. Similarly, a cardio-vascular module 273 may indicate a frequency, such as number of days per week, a duration, such as the number of minutes of particular type of exercise, as well as an intensity.

The parameters 294a, 294b, for a cardio-vascular regimen 273 may be coupled with a strength training regimen 274. Frequency is a typical selection, although number of repetitions and type of exercise may be included. However, strength training is often quite specific and need only be designated in terms of frequency.

Likewise, a designation 275 that no exercise is appropriate or recommended may also be selected. Similarly, a restriction module 276 may provide recommendations, which may be articulated in a text box 277 providing a physician 94 the freedom to specify in appropriate language and detail the restrictions or recommendations expected. Thus, no long lists of options are required. Rather, a text message 277 may be received with the prescription 76, thus informing both the patient 96 and a professional 98.

A tolerance testing module 278 may be represented and engaged by a tolerance testing button 278. It may identify any requirement or request for tolerance testing prior to, during, after, or otherwise related to an exercise regimen 76 or prescription 76.

In the illustrated embodiment, patient information may be minimized in the administrative window 251 invoking the administrative module 251. Thus, the patient selection 260 and referral selection 262 may be augmented by an even further abbreviated record excerpt 261 identifying a patient. Thus, on a single screen may be presented to a physician 94, the center selection module 290.

In this module, a search window 291 may be implemented, as well as an option selection 292. The option selection 292 will typically provide key but comparatively abbreviated information facilitating selection of a particular option for a center 106 at which the prescription 76 should be fulfilled.

Likewise, the center selection module 290 may include identification of a specific professional 94. Typically, however, a particular center 106 will have particular specialists 98 who will be responsible for different aspects, or the single aspect, if appropriate, associated with a prescription 76.

An educational support 293, and other supporting elements as well as associated document printing 296 and sending 295 buttons, as well as a closure button 292 may be presented.

Accordingly, navigation becomes simple, standard, minimizes reading, and does not change significantly in format between patients, prescriptions, centers, conditions, or the like. The minimization of reading, standardization of formatting, and identification of key parameters needed by physicians supports a rapid selection within seconds of input of minimal key information.

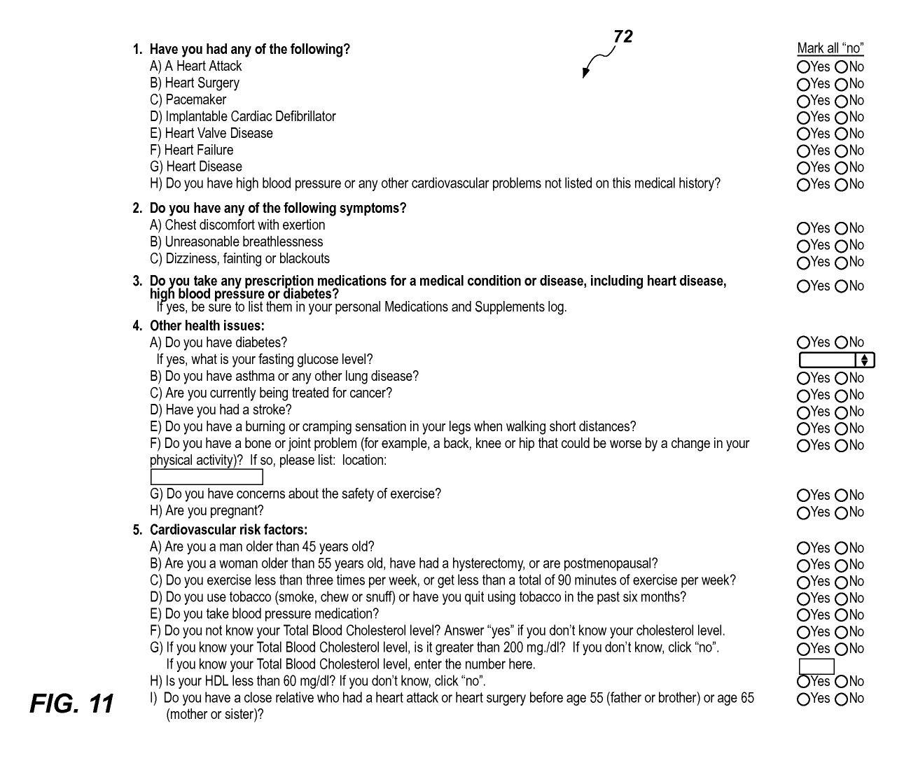

Referring to FIG. 11, in certain embodiments, a patient record 72 may include massive quantities of information. In the illustrated embodiment, an abbreviated record 72 is illustrated identifying specific situations. For example, have certain events occurred, do certain symptoms exist, are certain medications being used, or do a certain other health issues exist? Each of these questions has several common options that may bear directly on the suitability of a prescription 76. Similarly, other cardio-vascular risk factors may be included. Accordingly, the record 72 presented to a patient for addition to the patient record 72 needed for the position assessment 74 may likewise be considerably abbreviated.

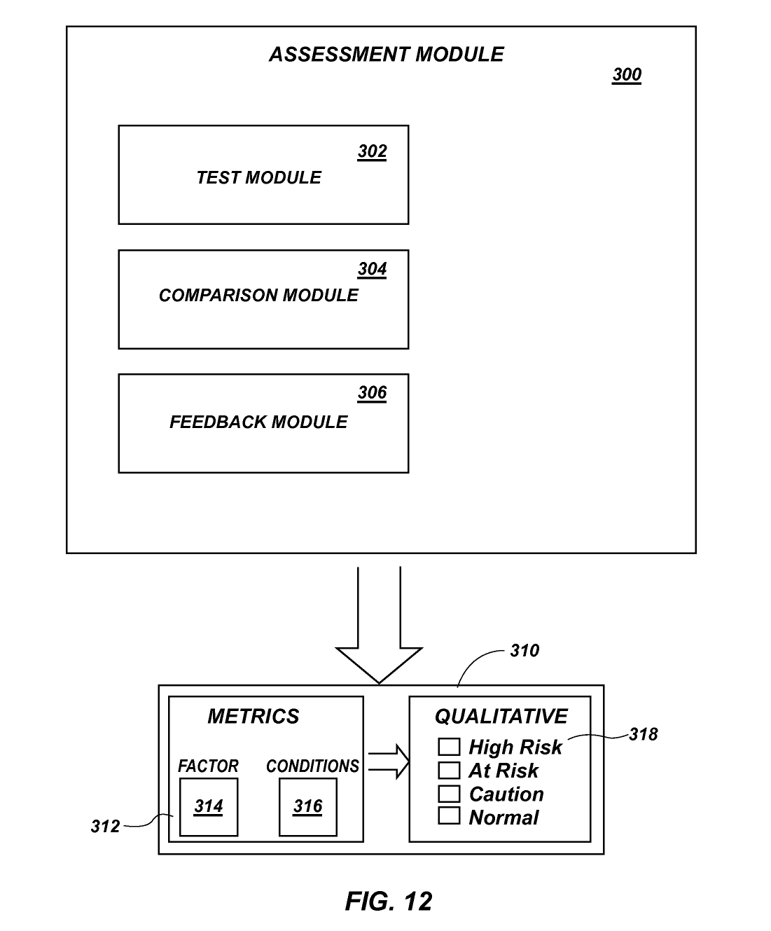

Referring to FIG. 12, an assessment module 296 may include a test module 297 for operating and processing information for testing. Similarly, a comparison module 298 may be included for assessing the progress, condition, effectiveness, or improvement of a patient 96 implementing a prescription 76. In the illustrated embodiment, a feedback module 299 may be responsible to provide back to the database 100, and possibly to the physician 94, professional 98, or center 106, directly information regarding the execution of the prescription 76 by a patient 96.

In certain embodiments, the feedback module 299 may actually provide information back to the device 104 during use by a user 96. Warnings, progress, motivation, reporting, and the like may be used as additional motivation for a user patient 96. Ultimately, the assessment module 296 may provide back to a database 200 or any of the persons involved with an exercise prescription 76, a report 300. The report 300 includes various metrics. Particular factors in the health profile or patient record 72 may be identified, as well as the status of various conditions. Meanwhile, any qualitative assessment, such as the degree of risk that a patient is exposed to by doing exercise, or as a result of the exercise, including a reduction of risk may also be included in a report 300.

A prescription process for specifying certain exercise regimens for a patient may address a chronic condition. Various physical facilities, such as hospitals, or professional groups of physicians or medical professionals, both, or some combination or subcombination thereof, may be connected in a computerized system to facilitate a prescription of an exercise regimen in conjunction with a recommendation by a physician.

A computerized prescription system may provide to a physician, ready access to minimal but adequate patient information in order to identify a patient. Data is quickly accessible, yet only a minimal amount need be displayed. Identifications of the most likely chronic health conditions to be treated by exercise, or which may affect an ability to exercise, are listed for ready selection.

A prescription may specify certain exercise regimens for a patient, addressing a chronic condition. Execution of exercise prescriptions may rely on equipment remote from a doctor. The computer system may integrate or consolidate information gathered from various equipment, in one or more facilities. The system may assist in tracking compliance of a patient with an exercise prescription. Automatic recommendations for exercise prescription may be created by a computerized system and proposed to a physician for adoption, modification, or rejection.

A facility module provides to health and fitness professionals a tool to manage members including proposed workout programs to meet the needs of exercise participants, physicians, and collect and manage health metrics. Meanwhile, a patient module permits patients to track progress, compliance, and otherwise implement an exercise program in a portable system, such as an application on a smart phone or PDA by simple uploading, downloading, and tracking of data, as well as providing information, communications, and reminders to a patient (user).

The present invention may be embodied in other specific forms without departing from its purposes, functions, structures, or operational characteristics. The described embodiments are to be considered in all respects only as illustrative, and not restrictive. The scope of the invention is, therefor, indicated by the appended claims, rather than by the foregoing description. All changes which come within the meaning and range of equivalency of the claims are to be embraced within their scope.

What is claimed and desired to be secured by United States Letters Patent is:

1. A method of computerized exercise prescription, the method comprising:
providing a system of internetworked computers, wherein the system comprises at least one processor operably connected to memory, the memory being non-transitory, computer readable, and storing modules comprising instructions programmed to execute on the at least one processor;
enrolling, by a physician module, a patient by identifying the patient uniquely;
assessing, by a physician module, a chronic condition of the patient, the chronic condition affecting at least one of suitability, advisability, efficacy, and risk to the patient of potential exercises, if conducted by the patient; and
determining, by the physician module, an exercise prescription comprising a regimen directed to the patient, based on the chronic condition.

2. The method of claim 1, further comprising:
calculating, by the physician module, selection criteria for determining a center module corresponding to a center for exercise, the exercise prescription for execution by the patient; and
communicating the selection criteria to the center module.

3. The method of claim 2, further comprising:
conducting, by the center module, control over an exercise machine in accordance with the exercise prescription comprising an exercise protocol;
controlling by the exercise machine, the exercise protocol during use by a patient corresponding to the exercise prescription; and
determining, by the center module, compliance data corresponding to the exercise as conducted by the patient.

4. The method of claim 3, further comprising:
analyzing, by the physician module, report data corresponding to the reporting.

5. The method of claim 1, wherein the selecting is based on at least one of:
the susceptibility of the chronic condition to remediation by the exercise prescription; and
avoidance of at least one adverse effect on the patient, based on the chronic condition.

6. The method of claim 1, wherein the exercise regimen is selected from cardio-pulmonary rehabilitation.

7. The method of claim 6, wherein selecting is based on analyzing an input to the physician module, from at least one of a patient record and a physician interview conducted with the patient based on inquiries determined during the interview by the physician module.

8. The method of claim 7, wherein selecting is based on intervention, by a physician, countervailing a recommended result output by the physician module in response to analysis by the physician module.

9. The method of claim 7, wherein selecting is based on previous patient compliance analyzed by at least one of the center module and the physician module.

10. The method of claim 7, further comprising:
inputting into the physician module patient data based on patient input corresponding directly with operation of the physician module, and received thereby proximate the time of the selecting; and
deleting the patient input from memory after the providing the exercise prescription.

11. The method of claim 10, further comprising deleting, by at least one of the physician module and center module, at least one of private information and linking information connecting the private information to identification information corresponding to the patient.

12. The method of claim 1, further comprising:
providing a database, comprising records and a database engine, the database engine being programmed to create, maintain, and search the records;
providing, by at least one computer of the internetworked computers, into the database, data characterizing a plurality of physicians, patients, chronic medical conditions, and centers selectable for implementing a plurality of exercise regimens to be selected.

13. The method of claim 12, further comprising:
requesting, by the physician module, from the database, condition data corresponding to the client, based on the identifying; and
providing, by the physician module, the chronic condition based on at least one of the condition data, an input by a physician, and a combination thereof.

14. The method of claim 1, further comprising:
operating, by the patient, an exercise machine corresponding to the center module; and
controlling, by the center module, the exercise machine in accordance with the exercise prescription.

15. The method of claim 14, wherein:
a center module corresponds to a center selected from a facility, a health professional, and a group of health professionals;
the center module, is further programmed to receive the exercise prescription;
the center module, is further programmed to manage members comprising health professionals affiliated with the center; and
the method further comprises providing to the members, by the center module, exercise programs automatically calculated to comply with the exercise prescription.

16. The method of claim 15, wherein at least one of the physician module, center module, and the patient module is further programmed to analyze health metrics associated with the patient.

17. A system comprising:
a plurality of computers, associated with at least one physician, at least one health professional, distinct and independent from the at least one physician, and a patient, distinct and independent from the at least one physician and the at least one health professional;
a plurality of modules, comprising a physician module, a center module, and a patient module corresponding to the at least one physician, the at least one center, and the at least one patient, respectively and executing on a respective physician computer, center computer, and patient computer;
a plurality of exercise machines operably connected to at least one computer of the plurality of computers, and being controlled by the plurality of modules analyzing patient information and determining thereby an exercise prescription based on a chronic condition of the patient associated with the patient computer; and
a tracking module tracking exercise of a user as a patient and calculating a compliance measure provided to at least one of the center module and the physician module to characterize compliance with the exercise protocol by the patient.

18. The system of claim 17, further comprising:
the physician computer operably connected to an internetwork and programmed to create an exercise prescription directed to a patient, based on the chronic condition, and correspond, in accordance therewith, to at least one of the center computer and the physician computer the exercise prescription;
a system computer, selected from the physician computer, the center computer, the patient computer, and another computer, executing a database engine accessing a database to complete at least one of creating, modify, and search records in the database, wherein the records include at least one of identifying patient information, health information corresponding to patients, condition data characterizing chronic health conditions corresponding to patients, and criteria for selecting a chronic health condition based on the health information;
the physician module comprising an exercise prescription module automatically creating an exercise prescription corresponding to a patient, based upon the chronic health condition; and
the physician module, further comprising at least one of a condition module programmed to present pre-screened list of conditions related to exercise for selection of a selected condition, a history module programmed to extract patient data from a history corresponding to the patient, a suggestion module, programmed to provide a suggested prescription by processing the selected condition and the patient data, and the prescription module programmed to provide the exercise prescription based on processing the suggested prescription and physician inputs.

19. An article comprising a memory, non-transitory, computer readable, and storing data structures comprising modules executable on computing devices, the modules comprising:
a physician module,
a center module, and
a patient module,
the physician module, further comprising;
a condition module programmed to present pre-screened list of conditions related to exercise for selection of a selected condition, a history module programmed to extract patient data from a history corresponding to the patient,
a suggestion module, programmed to provide a suggested prescription by processing the selected condition and the patient data, and
a prescription module programmed to provide an exercise prescription based on processing the suggested prescription and physician inputs.
